(19) United States
(12) Patent Application Publication
(10) Pub. No.: US 2010/0104085 A1
(43) Pub. Date: Apr. 29, 2010

(54) METHOD ENABLING INTEROPERABLE COMMUNICATION BETWEEN REAL AND VIRTUAL COMMUNITIES

(75) Inventors: Serge Papillon, Nozay (FR); Sylvain Squedin, Nozay (FR)

Correspondence Address: FAY SHARPE/LUCENT, 1228 Euclid Avenue, 5th Floor, The Halle Building, Cleveland, OH, 44115-1843, US

(73) Assignee: Alcatel-Lucent

(21) Appl. No.: 12/566,811

(22) Filed: Sep. 25, 2009

(30) Foreign Application Priority Data
Sep. 26, 2008 (FR) 0805332

(51) Int. Cl. H04M 7/00

(52) U.S. Cl. 379/220.01

(57) ABSTRACT

A method for establishing communication between a calling party and a called party by means of user agents connected to communication networks (30) having a control unit (50), which method comprises the following steps:
retrieving a communication session initiated by the calling party and controlled by the corresponding control unit, this session comprising an initialization request made by a user agent corresponding to the calling party and addressed to the called party,
determining, based on the initialization request, an identifier corresponding to the called party and the communication format;
based on the identifier, and based on at least one predetermined criterion, selecting a usable user agent from a predetermined list of user agents corresponding to the called party,
adapting the session initiated by the calling party to the selected user agent, by at least:
   converting the identifier used by the calling party to designate the called party into an identifier compatible with the selected user agent;
   converting the communication format used by the calling party into a communication format supported by the selected user agent;
   reformulating the initiated session using the thereby converted identifier and communication format;
resubmitting the thereby adapted communication session to the control unit.

The present invention pertains to the field of multimodal communication applications implemented in telecommunications networks. In particular, its object is a method and a system for interoperable communication between the communication platforms which connect together terminals such as computers, mobile terminals (mobile telephones, personal digital assistants, etc.), fixed terminals (landline telephones, faxes, etc.), or others.

Created by one or more administrators, a virtual community, also known as an online community, denotes a group of users within a network who generally share an interest, subject, or passion. For example, the virtual communities of forums, blogs, online games, or instant messaging services may be cited.

The purpose of a community may be social, commercial, or educational. Any user interested by that subject may join the community and thereby interact with people with similar interests. A virtual community enables each of its members to log in and interact with other members of his or her choice. One example of interactivity consists of conveying or sharing content. For example, a user may participate in online games, upload articles, photos, songs, and videos, or initiate text, voice, or visual communication.

The number of virtual communities, and their population, is continuously increasing. By way of a non-limiting example, massively multiplayer online games form communities that include hundreds of thousands, or even millions of members. This is a universe that is simultaneously accessible over a network by a very large number of players. These communities evolve independently and tend to expand as the availability of access to the network increases.

From the user's viewpoint, interactivity within a virtual community—i.e. the ability for the user to communicate within the community—assumes that the user is a member of it. Communications between communities are not necessarily possible. However, there are platforms which jointly support a certain (finite) number of virtual communities. For example, one may cite the Trillian platform, which is capable of connecting different instant messaging platforms, such as MSN, Yahoo, and ICQ, that are incompatible by nature. This entails what is known as the intra-interactivity of virtual communities.

Identification within virtual communities is generally administered by aliases, also known as pseudonyms or logins. These logins are chosen by the user, and they do not necessarily (and in practice, and generally don't) describe or disclose the user's actual identity. In fact, one of their functions is to preserve the anonymity of the user, who may have several aliases. These identifiers are generally visible by the other members of the community, and within the communities, are not considered private data.

The alias may take several forms, such as a string of characters, a symbol, an avatar, an icon, or an image.

At the same time, the development and expansion of the coverage of telecommunications technologies in the real world (mobile communications; fixed communications) are also leading to an increase in the number of real communities and in the populations of these communities, but compared with virtual communities, this increase is much lower.

Interactivity within real communities generally involves private identifiers which disclose, or at least describe, their owner's identity: a telephone number, a fax number, a first or last name, an IP address, or an e-mail address. One example of interactivity within real communities consists of establishing voice, visual, or text communication between two or more members.

It has been observed that an increasing number of users feel a need for interactivity between real and virtual communities, regardless of their types.

However, expanded interactivity (between communities) poses several problems.

The first problem is moral. The members of virtual communities are distrustful of having their private data disclosed (particularly their land-line/mobile telephone number, name, or e-mail address). Consequently, users, contrary to their needs, are reluctant to request that such communication between communities be permitted.

The second problem, a technical one, resides in the incompatibility between communication platforms and protocols (mobile, landline, IP). For example, one may cite online gaming platforms and fixed communication platforms.

Nevertheless, solutions have been proposed.

To that effect, the document US 2008/052363 describes an interoperable messaging system which makes it possible to communicate a text-based instant message with or without an audio/video attachment (an MSN message, AOL message, SMS, MMS, etc.) between different messaging platforms and between fixed and mobile terminals. This system adapts the message to be sent to the receiving system (carrier, form, etc.). This interactivity between communities is time-delayed.

The methods and systems of this type currently in use are imperfect, particularly due to the absence of an interoperable system between all text and audiovisual communications platforms, which would be capable of connecting together all real and virtual communities while maintaining the confidentiality of users' private identifiers.

The objectives achieved by the invention, performed jointly or individually to remedy the aforementioned drawbacks, are as follows:
overcoming the distinction between real and virtual communities, and therefore making it possible to initiate communication between all communication platforms, no matter what communication formats they support or the nature of the communities that they lead to. In other words, enabling the convergence of communities;
encouraging real-time interactivity between the members of the real and virtual communities, by using appropriate formats and communication platforms to establish such interactivity;
guaranteeing secure interactivity between the real and virtual communities, i.e. establishing communication without disclosing the users' private identifiers (for example, establishing telephone communication, which requires a private identifier, by using a public identifier such as an alias);
making it possible to systemically establish communication between a caller and a recipient.

For that purpose, the invention, according to a first aspect, pertains to a method for establishing communication between a calling party and a called party by means of user agents connected to communication networks having a control unit, which method comprises the following steps:
retrieving a communication session initiated by the calling party and controlled by the corresponding control unit, this session comprising an initialization request made by a user agent corresponding to the calling party and addressed to the called party,
determining, based on the initialization request, an identifier corresponding to the called party and the communication format;
based on the identifier, and based on at least one predetermined criterion, selecting a usable user agent from a predetermined list of user agents corresponding to the called party,
adapting the session initiated by the calling party to the selected user agent, by at least:
   converting the identifier used by the calling party to designate the called party into an identifier compatible with the selected user agent;
   converting the communication format used by the calling party into a communication format supported by the selected user agent;
   reformulating the initiated session using the thereby converted identifier and communication format;
resubmitting the thereby adapted communication session to the control unit.

The invention, according to a second aspect, pertains to a system for establishing communication between a calling party and a called party by means of user agents connected to communication networks having a control unit, which system comprises the following modules:
A module for retrieving a session initiated by the calling party and controlled by the control unit, provided that a user agent corresponding to the calling party has formulated a request to initialize a communication session addressed to the called party and comprising an identifier corresponding to the called party;
A module for selecting, based on the identifier contained within the communication session initialization request and based on at least one predetermined criterion, a usable user agent chosen from a predetermined list of user agents corresponding to the called party;
A module for adapting the session initiated by the calling party to the selected user agent for at least:
   converting the identifier used by the calling party to designate the called party into an identifier compatible with the selected user agent;
   converting the communication format used by the calling party into a communication format supported by the selected user agent;
   reformulating the initiated session using the thereby converted identifier and communication format;
A module for resubmitting the adapted communication session to the control unit.

According to a third aspect, the invention pertains to a computer program product implemented on a memory medium, which may be implemented within a computer processing unit, and comprises instructions for implementing the method summarized above.

The invention makes possible to establish communication between multiple communication platforms which result in real and virtual communities. It particularly makes it possible to overcome incompatibility between the communications platforms.

Furthermore, the present invention enables a member of the community A to establish communication with another member of a community B, whose identifier he or she knows, within a community C. C may be A or B, or any other community (A, B, and C being communities of different natures (virtual, real) which support different communication formats (text, audio, video)).

Other characteristics and benefits of the invention will become more clearly and fully apparent upon reading the description below of a preferred variant implementation of the method and embodiment of the system, with reference to the attached drawings, in which:

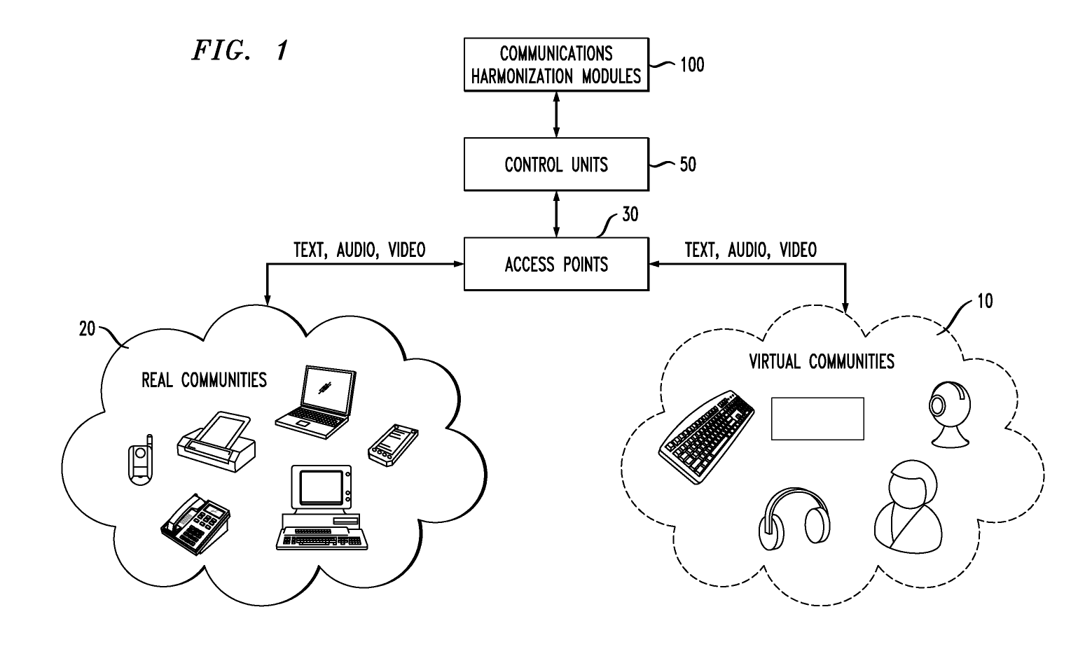

FIG. 1, as an illustrative example, depicts the incorporation of the present invention into a general telecommunications network architecture;

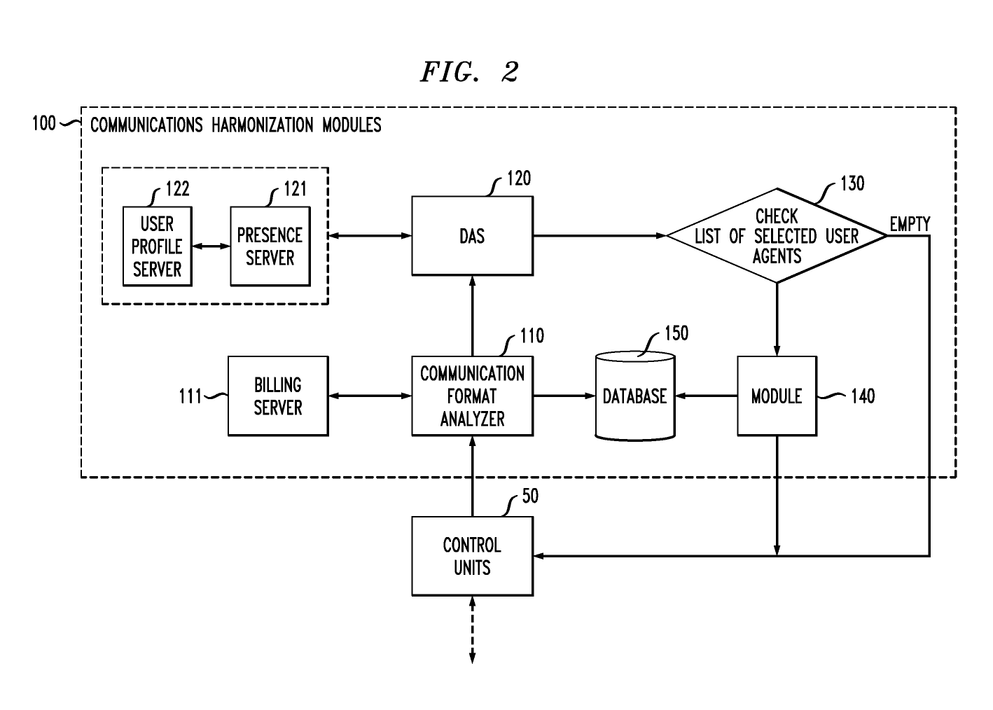

FIG. 2 represents a functional, non-limiting depiction of the inventive system.

In FIG. 1, a set of virtual communities 10 and a set of real communities 20 which support different communications formats, such as text communication, voice communication, visual communication, or any combination thereof, have been depicted. By way of example, an instant messaging user agent makes it possible to establish text-audio-video communication, while another user agent makes it possible to establish audiovisual communication.

The virtual 10 and real 20 communities may be connected to one another by means of a communication system comprising one or more access points 30, one or more control units 50, and one or more communications harmonization modules 100.

The user agents' communication requests are sent/received via the access points 30 of different wireless or wired communications networks. By way of example, each access point 30 comprises connections to an ADSL network, a WLAN network, a GSM network, a PSTN network, etc.

Each access point 30 forms an interface between the user agent and the control unit 50 of the communications networks.

The control unit 50 is an entity which enables user agents to be “seen” by one another (meaning, to have the ability to interact) and to negotiate the characteristics of a communication session that they wish to share. This unit 50 is particularly a Call/Session Control Function (CSCF) supporting SIP (Session Initialisation Protocol).

The control unit 50, in practice, comprises application servers, which communicate with the harmonization module 100, whose internal architecture is detailed in FIG. 2.

The system 100 firstly comprises a communication format analyzer 110 making it possible to determine the recipient's identifier, specify the initialized communication's format, and identify its source platform. For example, the analyzer 110 makes it possible to distinguish written communication coming from an e-mail server, addressed to the identifier “+33112345678”, a voice communication coming from a mobile/fixed telecommunications network addressed to the identifier “example@gmail.com”, a written communication coming from a server running a game or forum and addressed to the identifier “player 1”, and an audiovisual communication coming from an instant messaging server addressed to the identifier “+33612345678”. For this purpose, the analyzer 110 is assisted by a database 150. This database comprises expanded metadata for all communications platforms and formats. The database 150 is regularly updated in order to add any new communication formats, and to save any changes to the communication formats supported by the communication platforms. By way of example, it may be an e-mail application that incorporates audiovisual communication, or a mobile telecommunication network that offers a video communication service. It should be noted that the analyzer 110 did not make any changes to the communication session initialized by the calling party.

The communication system 100 secondly comprises a module 120 programmed to reciprocally associate a user's identifier within a community to his or her identifier within another community. By way of a non-limiting example, the module 120, hereafter known as the DAS (Domain Alias System) by analogy to a DNS (Domain Name System), makes it possible to associate an alias with a telephone number and vice versa, an e-mail address with a telephone number and vice versa, an alias with an e-mail address and vice versa, an alias with another alias, etc. In particular, the DAS 120 makes it possible to link together a user's private identifiers and his and her public identifiers, and vice versa.

The communication system 100 thirdly comprises a presence server 121 connected the association module and making it possible to index the list of usable user agents, i.e. the ones whose corresponding user may be considered—or deemed to be—reachable. Different methods are possible to perform this indexing, for example:
the user agent may report its connection to the presence server 121,
the presence server 121 may regularly consult the user agent's status,
the presence server 121 may consult intermediate network entities that may submit information on the user agent's accessibility.

The presence server 121 also retrieves complementary information on each user agent, such as its status (busy, free, away, etc.), its version, its complementary modules, the current state of the different modules (whether they are on/off, whether the graphics card is on/off, etc.).

A user profile server 122 is connected to the presence server 121 to enable the acceptance of preferences that each user may save. Thus, a user profile may, for example, comprise:
the list of (user agent, identifier) pairs that a user has,
the list of public identifiers and private identifiers,
the ordered list of user agents at which the user prefers to be reached,
the list of communities which cannot reach him or her via a list of user agents,
the communication format, if a user agent supports more than one communication format.

Advantageously, the user profile server 122 may be automatically configured, or personalized by the users themselves. Furthermore, a user may have multiple profiles. For example, a user may have a “home” profile, a “work” profile, a “competition” profile, a “weekend” profile, etc.

Based on the identifier provided by the analyzer 110, the user profile provided by the profile server 122, and presence information provided by the presence server 121, the DAS 120 selects the usable user agent if one exists, and the corresponding identifier.

The communication system 100 further comprises a module 140 for adapting communication formats, which converts the format of the initialized communication into a communication format supported by the user agent selected by the DAS, in order to enable proper reception, via the called user agent, of the session initialized by the calling party. By way of example, the user agent used by the calling party may be a telephone (landline or mobile), while the user agent selected by the DAS is a discussion forum.

The module 140 makes it possible to convert the content of the communication session, for example from audio to text, from text to audio, from a video to images extracted from a video, from a video to audio, etc. This conversion function may be implemented using off-the-shelf products, such as Text To Speech, published by Oddcast. The module 140 also makes it possible to adapt the communication session to the characteristics of the receiving user agent (form, protocol, etc.). The module 140 is connected to the database 150 in order to adapt the communication session initialized by the calling user agent to the called user agent.

The communication session thereby adapted to the receiving user agent is then transmitted to the control unit 50.

It should be noted that the list of selected user agents may be empty, such as in the event that the called party cannot be reached by any means, or when his or her preferences do not correspond to any usable user agents.

A test module 130 checks the list of selected user agents. If the list is empty, the session returned to the unit 50 is identical to the initially retrieved communication session.

Advantageously, the DAS 120 makes it possible, taking into account both the presence criteria and user preference criteria, to select more than one receiving user agent.

Ultimately, this entails interaction between the communities themselves.

In the event that this interactivity is a pay service, the analysis module 110 is connected to a billing server 111, which may authorize multiple payment methods.

The system 50 which has just been described thereby makes it possible to establish communication between a calling party and a called party.

First, the communication session initialized by the calling party and controlled by the corresponding control unit is retrieved by the module 110 in order to be analyzed by it afterward.

The analysis results in determining both the identifier corresponding to the called party and the communication format.

Based on this information, and depending on at least one predetermined criterion (in this situation, the presence of the called user, combined with his or her preferences), the DAS 120 selects at least one usable user agent from the list of user agents corresponding to the called party.

The session is then adapted by the module 140 to the user agent thereby selected, then is sent to the control unit so that the user agents of the calling party and the called party can actually enter communication.

Although the communication system 100 as it has just been described is separate from the control unit 50, it may be incorporated at least partially into an application server within it.

1. A method for establishing communication between a calling party and a called party by means of user agents connected to communication networks (30) having a control unit (50), wherein it comprises the following steps:
retrieving a communication session initiated by the calling party and controlled by the corresponding control unit, this session comprising an initialization request made by a user agent corresponding to the calling party and addressed to the called party,
determining, based on the initialization request, an identifier corresponding to the called party and the communication format;
based on the identifier, and based on at least one predetermined criterion, selecting a usable user agent from a predetermined list of user agents corresponding to the called party,
adapting the session initiated by the calling party to the selected user agent, by at least:
converting the identifier used by the calling party to designate the called party into an identifier compatible with the selected user agent;
converting the communication format used by the calling party into a communication format supported by the selected user agent;
reformulating the initiated session using the thereby converted identifier and communication format;
resubmitting the thereby adapted communication session to the control unit.

2. A method according to claim 1, wherein the conversion of the identifier is performed by means of an association system (120) programmed to convert any identifier regarding a user agent on the list into any other identifier corresponding to another user agent on the same list.

3. A method according to claim 1, wherein it comprises a step of indexing, by means of a presence server (121), the list of user agents, so as to identify therein a subset of usable user agents.

4. A method according to claim 1, wherein selecting the user agent receiving the session initialized by the calling party takes into account the recipient's preferences.

5. A method according to claim 1, wherein whenever no user agent can be selected, the initially retrieved session is resubmitted to the control unit without any changes.

6. A system for establishing communication between a calling party and a called party by means of user agents connected to communication networks (30) having a control unit (50), wherein it comprises the following modules:
A module for retrieving a session initiated by the calling party and controlled by the control unit, provided that a user agent corresponding to the calling party has formulated a request to initialize a communication session addressed to the called party and comprising an identifier corresponding to the called party;
A module for selecting, based on the identifier contained within the communication session initialization request and based on at least one predetermined criterion, a usable user agent chosen from a predetermined list of user agents corresponding to the called party;
A module for adapting the session initiated by the calling party to the selected user agent for at least:
converting the identifier used by the calling party to designate the called party into an identifier compatible with the selected user agent;
converting the communication format used by the calling party into a communication format supported by the selected user agent;
reformulating the initiated session using the thereby converted identifier and communication format;
A module for resubmitting the adapted communication session to the control unit.

7. A system according to claim 6, wherein it comprises a Domain Alias Server (120) programmed to convert any identifier regarding a user agent on the list into any other identifier corresponding to another user agent on the same list.

8. A system according to claim 8, wherein it comprises a presence server (121) programmed to index the list of user agents in order to identify the subset of user agents who may be reached at the time the session is initialized.

9. A method according to claim 1 implemented in a computer program product implemented on a memory medium, which may be implemented within a computer processing unit, and comprises instructions to implement the method.
